(19) United States
(12) Patent Application Publication
(10) Pub. No.: US 2005/0215709 A1
(43) Pub. Date: Sep. 29, 2005

(54) Conjugated diene-vinyl aromatic hydrocarbon copolymer containing siloxane compound for promoting abrasive resistance

(75) Inventors: Kung-Ksi Chan, Kaohsiung County (TW); Meng-Peng Li, Kaohsiung County (TW); Hsiao-Chung Chen, Kaohsiung City (TW)

Correspondence Address: BIRCH STEWART KOLASCH & BIRCH, PO BOX 747, FALLS CHURCH, VA, 22040-0747, US

(73) Assignee: TSRC Corporation

(21) Appl. No.: 11/087,857

(22) Filed: Mar. 24, 2005

(30) Foreign Application Priority Data
Mar. 26, 2004 (TW) 093108248

(51) Int. Cl. C08L 83/04; C08L 53/00

(52) U.S. Cl. 525/88; 525/100; 525/479

(57) ABSTRACT

The invention provides a conjugated diene-vinyl aromatic hydrocarbon copolymer containing a siloxane compound, which improves the abrasion resistance of the conjugated diene-vinyl aromatic hydrocarbon copolymer, comprising: 100 parts by weight of the conjugated diene-vinyl aromatic hydrocarbon copolymer and 0.1 to 50 parts by weight of the siloxane compound. The siloxane compound of the invention has a formula (I) as below: 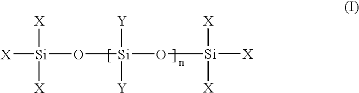
wherein each X independently represents C₁˜C₁₂ alkyl, C₁˜C₁₂ alkoxy, C₁˜C₁₂ cycloalkoxy, C₁˜C₁₂ alkenyl, C₁˜C₁₂ alkylamino, C₁˜C₁₂ alkylol, C₁˜C₁₂ thiol, halogen, carboxyl, hydroxyl, amino, aryl, or hydrogen; each Y independently represents C₁˜C₁₂ alkyl, C₁˜C₁₂ alkoxy, C₁˜C₁₂ cycloalkoxy, C₁˜C₁₂ alkenyl, C₁˜C₁₂ alkylamino, C₁˜C₁₂ alkylol, C₁˜C₁₂ thiol, halogen, carboxyl, aryl, or hydrogen; and n is an integer between 5 and 10,000.

### BACKGROUND

The invention relates to a conjugated diene-vinyl aromatic hydrocarbon copolymer containing a siloxane compound, and more particularly to a method of improving the abrasion resistance of the vinyl aromatic hydrocarbon-conjugated diene-vinyl aromatic hydrocarbon block copolymer by the siloxane compound.

In industry, conjugated dienes and vinyl aromatic hydrocarbons usually serve as monomers to form a thermoplastic rubber (TPR) under a block polymerization process. Due to phase separation, the thermoplastic rubber forms physical crosslinking and has good tensile strength. However, the thermoplastic rubber exhibits low abrasion resistance, weather resistance, heat resistance and oxidation resistance, thereby limiting its application greatly. Especially for low abrasion resistance, the thermoplastic rubber of the vinyl aromatic hydrocarbon-conjugated diene-vinyl aromatic hydrocarbon block copolymer is unsuited to application in high-quality products such as sports shoes and bicycle tires.

Conventionally, a polymer is cross-linked by vulcanization to be more abrasion resistance. Nevertheless, the vulcanization process has problems of high energy consumption, complicated steps, and a long cycle time.

### SUMMARY

Accordingly, the invention provides a method for improving the abrasion resistance of a conjugated diene-vinyl aromatic hydrocarbon copolymer. The invention improves the abrasion resistance of the conjugated diene-vinyl aromatic hydrocarbon block or alternating copolymer by a siloxane compound. Only a small amount of the siloxane compound is needed to improve the abrasion resistance of the copolymer. The invention can improve the abrasion resistance of the conjugated diene-vinyl aromatic hydrocarbon block copolymer nearly 10 times by the siloxane compound, which increases the added value of the product and expands the application fields thereof widely at the same time.

The invention also provides a siloxane compound which is stable and easy to obtain. The siloxane compound can be stored for a long time with good stability, and provide significant economic benefits.

To achieve these and other advantages, the invention provides a conjugated diene-vinyl aromatic hydrocarbon copolymer containing a siloxane compound, comprising:
100 parts by weight of the conjugated diene-vinyl aromatic hydrocarbon block copolymer; and
0.1 to 50 parts by weight of the siloxane compound, which has a formula (I) as below: 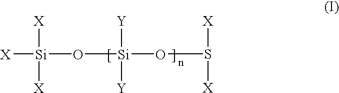
wherein each X independently represents C₁˜C₁₂ alkyl, C₁˜C₁₂ alkoxy, C₁˜C₁₂ cycloalkoxy, C₁˜C₁₂ alkenyl, C₁˜C₁₂ alkylamino, C₁˜C₁₂ alkylol, C₁˜C₁₂ thiol, halogen, carboxyl, hydroxyl, amino, aryl, or hydrogen; each Y independently represents C₁˜C₁₂ alkyl, C₁˜C₁₂ alkoxy, C₁˜C₁₂ cycloalkoxy, C₁˜C₁₂ alkenyl, C₁˜C₁₂ alkylamino, C₁˜C₁₂ alkylol, C₁˜C₁₂ thiol, halogen, carboxyl, aryl, or hydrogen; and n is an integer between 5 and 10,000.

The invention improves the abrasion resistance of the conjugated diene-vinyl aromatic hydrocarbon copolymer by the above siloxane compound (I). The siloxane compound represented by formula (I) is about 0.1 to 50 parts by weight, based on 100 parts by weight of the conjugated diene-vinyl aromatic hydrocarbon block copolymer.

### DESCRIPTION OF THE DRAWINGS

For a better understanding of the invention, reference is made to a detailed description to be read in conjunction with the accompanying drawings, in which:

FIG. 1 illustrates the relationship between the added amount of siloxane compound and abrasion resistance—Akron (c.c.); and

FIG. 2 illustrates the relationship between the added amount of siloxane compound and abrasion resistance—NBS (rev./1.54 mm).

### DETAILED DESCRIPTION OF THE INVENTION

A siloxane compound of the invention has a formula (I) as below: 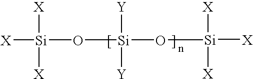
wherein each X independently represents C₁˜C₁₂ alkyl, C₁˜C₁₂ alkoxy, C₁˜C₁₂ cycloalkoxy, C₁˜C₁₂ alkenyl, C₁˜C₁₂ alkylamino, C₁˜C₁₂ alkylol, C₁˜C₁₂ thiol, halogen, carboxyl, hydroxyl, amino, aryl, or hydrogen; each Y independently represents C₁˜C₁₂ alkyl, C₁˜C₁₂ alkoxy, C₁˜C₁₂ cycloalkoxy, C₁˜C₁₂ alkenyl, C₁˜C₁₂ alkylamino, C₁˜C₁₂ alkylol, C₁˜C₁₂ thiol, halogen, carboxyl, aryl, or hydrogen; and n is an integer between 5 and 10,000, preferably an integer between 600 and 7000.

The siloxane compound of the invention may preferably have a viscosity between 100 and 300000 cp, present in an amount of about 1 to 2.5 parts by weight.

A conjugated diene-vinyl aromatic hydrocarbon copolymer of the invention may comprise a block copolymer or alternating copolymer, which has a number average molecular weight (Mn) between 50000 and 1000000 grams per mole. The vinyl aromatic hydrocarbon is about 10 to 50 wt %, based on the total amount of the conjugated diene-vinyl aromatic hydrocarbon copolymer.

In the invention, in order to disperse the siloxane compound in the conjugated diene-vinyl aromatic hydrocarbon copolymer completely, three possible methods of adding the siloxane compound to the conjugated diene-vinyl aromatic hydrocarbon copolymer are provided, as follows:

(1) Mix in liquid state: a siloxane compound is dissolved in an organic solvent, followed by mixing with a conjugated diene-vinyl aromatic hydrocarbon copolymer solution. In more detail, the conjugated diene-vinyl aromatic hydrocarbon copolymer solution is provided, and the siloxane compound is first dissolved in an organic solvent first. Next, the siloxane compound solution is mixed with the conjugated diene-vinyl aromatic hydrocarbon copolymer solution. Finally, after the solvent is removed, the conjugated diene-vinyl aromatic hydrocarbon copolymer containing the siloxane compound with improved abrasion resistance is obtained.

According to the invention, the solvent used to dissolve the siloxane compound is preferably an inert organic solvent, such as aromatic hydrocarbon, straight or branched hydrocarbon, cycloalkyl ether, or alicyclic hydrocarbon. The aromatic hydrocarbon may comprise organic solvents such as benzene, toluene, xylene, ethyl benzene, or the like. The straight or branched hydrocarbon, for example, may comprise pentane, hexane, heptane, octane, or the like. The cycloalkyl ether may comprise tetrahydrofuran. The alicyclic hydrocarbon may comprise cyclohexane, cycloheptane, methyl cycloheptane, or the like, among which, cyclohexane is preferred.

The siloxane compound is dissolved in the organic solvent at a temperature between 0 to 250° C. If the temperature is lower than 0° C., the siloxane compound may dissolve incompletely and separate. When the temperature is higher than 250° C., the siloxane compound and the copolymer may decompose, thereby reducing the abrasion resistance of the copolymer. The preferred mixing temperature is between 25 and 80° C.

A polymer solution of the invention is obtained by mixing the organic solvent having the siloxane compound with the conjugated diene-vinyl aromatic hydrocarbon copolymer solution, and the polymer may be condensed by adding a polar solvent. The polar solvent is not a suitable solvent for the copolymer, such as methanol or acetone. In addition, the polymer may also be obtained either by adding the polymer solution to hot water as a solvent and heating with stirring to evaporate the solvent, or heating the polymer solution directly.

(2) Blend in solid state: a siloxane compound is added to a conjugated diene-vinyl aromatic hydrocarbon copolymer directly to advance a melt-blending process. In more detail, the conjugated diene-vinyl aromatic hydrocarbon copolymer is provided initially in a melt state. Then, the siloxane compound is blended with the conjugated diene-vinyl aromatic hydrocarbon copolymer completely. After press molding, the conjugated diene-vinyl aromatic hydrocarbon copolymer with improved abrasion resistance is obtained.

The blending temperature may be between 100 and 250° C., depending on the melting point of the block polymer. For example, the blending temperature of the polystyrene-polybutadiene-polystyrene triblock copolymer can be between 110 and 180° C., and the preferred blending temperature between 120 and 150° C., which may be optionally adjusted according to the conditions.

(3) Blend in solid state: a siloxane compound and a solid-state polymer are melted and blended to produce a masterbatch, and the masterbatch is then melted and blended with a conjugated diene-vinyl aromatic hydrocarbon copolymer during a melt-blending process. In more detail, the siloxane compound is melted and blended with the polymer (either a homopolymer or a copolymer) to produce a masterbatch, and the masterbatch is then melted and blended with the conjugated diene-vinyl aromatic hydrocarbon copolymer. After press molding, the conjugated diene-vinyl aromatic hydrocarbon copolymer with improved abrasion resistance is obtained.

The above polymer, suitable for forming the masterbatch with the siloxane compound, may comprise a homopolymer or copolymer. The preferred homopolymer may comprise polyolefins, ethylenically unsaturated polyester, polyaromatic hydrocarbons, derivatives thereof, or combinations thereof. A concrete example may comprise polyethylene (PE), polypropylene (PP), or polystyrene (PS). The ratio of the siloxane compound to the homopolymer is about 1/100 and 99/100. The preferred copolymer may comprise a copolymer of olefin and aromatic hydrocarbon, polyolefin, a copolymer of olefin and ethylenically unsaturated ester, derivatives thereof, or combinations thereof. A concrete example may comprise poly(methyl methacrylate) (PMMA), polyethylene-vinyl acetate (EVA), or the like. The ratio of the siloxane compound to the copolymer is about 1/100 and 99/100.

Moreover, the above polymers, suitable for producing the masterbatch with the siloxane compound, may be formed by conventional techniques, such as anionic polymerization, cationic polymerization, free radical polymerization, complex polymerization, solution polymerization, emulsion polymerization and so on. It is preferred to use an organolithium compound as a catalyst initiator during the polymerizing process to obtain an active polymer, which has lithium atoms at the terminus of the molecular chains, thereby elongating the molecular chains during polymerizion after adding the monomers. A concrete example of the organolithium compound may comprise n-propyl lithium, isopropyl lithium, n-butyl lithium, n-pentyl lithium, benzyl lithium, methylbenzyl lithium, or the like. A concrete example of dilithium hydrocarbon compounds may comprise 1,4-dilithium butane, 1,5-dilithium pentane, 1,2-dilithium dibenzylethane, 1,4-dilithium-1,1,4,4 tetrabenzyl butane, 1,3- or 1,4-di(1-lithium-3 methyl amyl) benzene. The amount of organolithium compound added depends on the molecular weight of the polymer desired, which is usually between 0.05 and 5 weight percent, based on the total amount of the monomers.

The blending temperature may be between 100 and 250° C., which depends on the melting point of the block polymer. For example, the blending temperature of the polystyrene-polybutadiene-polystyrene triblock polymer can be between 110 to 180° C., and the preferred blending temperature between 120 to 150° C., which may be optionally adjusted according to the conditions.

According to the invention, an antioxidant is added after the siloxane compound is added to the conjugated diene-vinyl aromatic hydrocarbon copolymer for preserving in inert gas or atmosphere for a long time without affecting abrasion resistance. Therefore, the siloxane compound of the invention suits the needs of industry very well.

After the conjugated diene-vinyl aromatic hydrocarbon copolymer of the invention is blended with the siloxane compound, a high-value thermoplastic elastomer is obtained. Vinyl aromatic hydrocarbon monomer suitable for the invention may comprise styrene, tert-butylstyrene, δ-methylstyrene, o-methylstyrene, p-methylstyrene, divinyl benzene, 1,1-dibenzyl ethylene, vinylnaphthalene, N,N-dimethyl-p-vinylamine styrene, or N,N-diethyl-p-vinylamine styrene. A preferred example is styrene. Examples of the conjugated diene-vinyl aromatic hydrocarbon copolymer are butadiene/styrene copolymer or isoprene/styrene copolymer, such copolymers having a high industrial value.

In the invention, 0.5 to 2.5 wt % of the siloxane compound is enough for 100 grams of the conjugated diene-vinyl copolymer to improve abrasion resistance of the copolymer. If the added amount of the siloxane compound exceeds 2.5 wt %, the abrasion resistance will be better. However, it doesn't have economic benefits. The preferred added amount of the siloxane compound is about 0.5 to 2.5 wt % for 100 grams of the conjugated diene-vinyl copolymer, and the abrasion resistance of 1.0 to 2.0 wt % of the siloxane compound is particularly preferred.

While the invention is further illustrated for a better understanding by way of examples, it is to be understood that the invention is not limited thereto. The scope of the invention should be accorded with the appended claims.

### EXAMPLE 1

### Preparation of Polystyrene-Polybutadiene-Polystyrene (SBS) Block Copolymer:

A polystyrene-polybutadiene block copolymer was formed by anion polymerization, to which a coupling agent was added to obtain a copolymer solution of a four-armed polystyrene-polybutadiene-polystyrene block copolymer with a polystyrene content of 38.5 wt %, a molecular weight of 380,000 grams per mole, an oil content of 33.5 wt %, and a coupling ratio of 86%.

### EXAMPLE 2

1200 grams (a solid content of 26 wt %, 312 grams) of the SBS triblock copolymer solution of Example 1 were placed in a glass jar and thoroughly mixed. The copolymer solution (without a siloxane compound) was slowly added to hot water with stirring, and the solvent removed to obtain polymer colloidal particles. After drying with hot air at 100° C., the polymer colloidal particles were pressed by a heated calender and molded to test abrasion resistance. The result is listed in Table 1.

### EXAMPLE 3

1200 grams (a solid content of 26 wt %, 312 grams) of the SBS triblock copolymer solution of Example 1 were placed in a glass jar and thoroughly mixed. 6.3 grams of a siloxane compound were thoroughly mixed with 100 ml of cyclohexane in a beaker at room temperature, and the solution of the siloxane compound was then added to the SBS triblock copolymer solution and thoroughly mixed with stirring for 60 minutes. The mixed solution was slowly added to hot water with stirring, and the solvent removed to obtain polymer colloidal particles. After drying with hot air at 100° C., the polymer colloidal particles were pressed by a heated calender and molded to test abrasion resistance. The result is listed in Table 1.

### EXAMPLE 4

1200 grams (a solid content of 26 wt %, 312 grams) of the SBS triblock copolymer solution of Example 1 were placed in a glass jar and thoroughly mixed. 6.3 grams of a siloxane compound were thoroughly mixed with 100 ml of cyclohexane in a beaker at room temperature, and the solution of the siloxane compound was then added to the SBS triblock copolymer solution and thoroughly mixed with stirring for 60 minutes. The mixed solution was slowly added to hot water with stirring, and the solvent removed to obtain polymer colloidal particles. After drying with hot air at 100° C., the polymer colloidal particles were pressed by a heated calender and molded to test abrasion resistance. The result is listed in Table 1.

TABLE 1

| | Abrasion | Abrasion | Abrasion |
|---|---|---|---|
| | resistance | resistance | resistance |
| | -A(Akron) | -B(Akron) | -C(NBS) |
| Example | (cc) | (cc) | (rev.) |
| Example 2 | 0.31 | 0.78 | 300 |
| Example 3 | 0.039 | 0.174 | 790 |
| Example 4 | 0.017 | 0.079 | 1320 |

Abrasion resistance A(Akron) test condition: 2 lb/15°/2000 rev.
Abrasion resistance B(Akron) test condition: 6 lb/15°/3300 rev.
Abrasion resistance C(NBS) test condition: The number of revolutions
required to abrade 1.54 mm of the test specimen.
Example 3: The siloxane compound has a formula as shown in (I),
wherein the X = Y = —CH3, and a viscosity of about 350 cp.
Example 4: The siloxane compound has a formula as below, and a
viscosity of about 4500 cp:

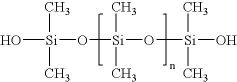

Table 1 illustrates that the SBS copolymer in absence of the siloxane compound (Example 2) has poor abrasion resistance (Akron: 0.31 cc). However, the abrasion resistance of the SBS copolymers (Examples 3 and 4) was improved after 2 wt % of the siloxane compound was added (respectively up to 0.039 cc and 0.017 cc of abrasion loss by Akron abrasion tester).

### EXAMPLE 5

1200 grams of the SBS triblock copolymer solution of Example 1 were placed in a glass jar and thoroughly mixed. 0.5 wt %, 1.0 wt %, 1.5 wt %, 2.0 wt %, and 2.5 wt % of the siloxane compound (as used in Example 4), based on the total amounts of the SBS polymer and oil, were placed in individual beakers and thoroughly mixed with 100 ml of cyclohexane at room temperature, and the solutions of the siloxane compound were then added to the SBS triblock copolymer solutions individually and thoroughly mixed with stirring for 60 minutes. Each mixed solution was slowly added to hot water with stirring, and the solvent removed to obtain polymer colloidal particles. After drying with hot air at 100° C., the polymer colloidal particles were pressed by a heated calender and molded to test abrasion resistance. The results are listed in Table 2.

TABLE 2

| | | Abrasion | Abrasion |
|---|---|---|---|
| | siloxane compound | resistance - | resistance - |
| Example | Added amount (wt %) | B(Akron) (cc) | C(NBS) (rev.) |
| Example 5 | 0 | 0.72 | 240 |
| | 0.5 | 0.34 | 284 |
| | 1.0 | 0.18 | 405 |
| | 1.5 | 0.12 | 666 |
| | 2.5 | 0.08 | 1122 |

Abrasion resistance B(Akron) test condition: 6 lb/15°/3300 rev.
Abrasion resistance C(NBS) test condition: The number of revolutions required to abrade 1.54 mm of the test specimen.

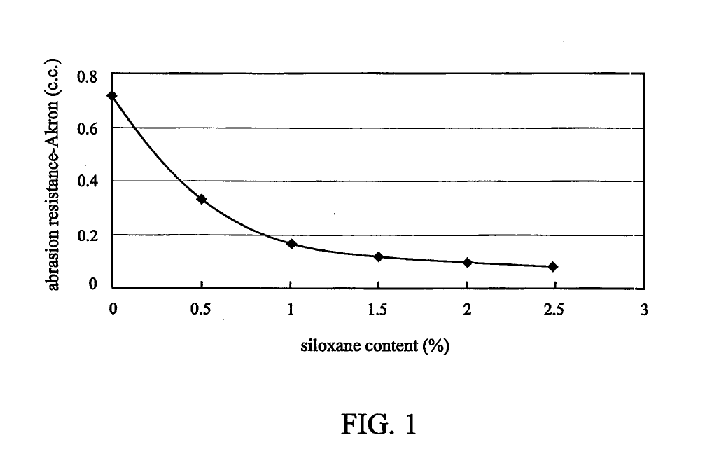

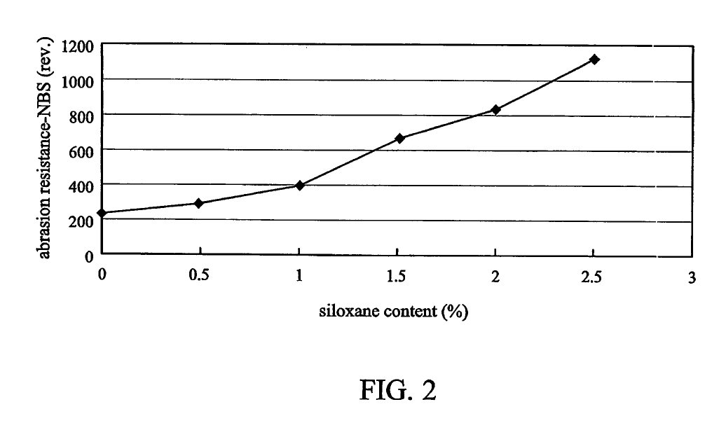

Table 2 illustrates that the SBS polymer in absence of the siloxane compound has poor abrasion resistance (Akron: 0.72 cc). However, the abrasion resistances of the SBS polymers improved after various amounts of the siloxane compound were added. The abrasion resistance of the SBS polymers increases with the content of the siloxane compound. FIG. 1 illustrates the relationship between the content of the siloxane compound and the abrasion resistance—Akron (c.c.) of the SBS polymer, and FIG. 2 illustrates the relationship between the content of the siloxane compound and the abrasion resistance—NBS (rev.) of the SBS polymer, which shows that the abrasion resistance is in direct proportion to the content of the siloxane compound.

### EXAMPLE 6

The dried polymer colloidal particles of the SBS triblock copolymer in Example 1 was melted in a heated mill, and 2 wt % of the siloxane compound (as used in Example 4) was applied into the calender directly and thoroughly mixed. After pressing and molding, abrasion resistance was tested, and the result is listed in Table 3.

TABLE 3

| | | Abrasion | |
|---|---|---|---|
| | siloxane compound | resistance - | Abrasion resistance - |
| Example | Added value (wt %) | B(Akron) (cc) | C(NBS) (rev.) |
| Example 6 | 0 | 0.72 | 240 |
| | 2.0 | 0.08 | 1122 |

Abrasion resistance B(Akron) test condition: 6 lb/15°/3300 rev.
Abrasion resistance C(NBS) test condition: The number of revolutions required to abrade 1.54 mm of the test specimen.

### EXAMPLE 7

1200 grams (a solid content of 26 wt %, 312 grams) of the SBS triblock copolymer solution of Example 1 were placed in a glass jar and thoroughly mixed. 6.3 grams of a siloxane compound were thoroughly mixed with 100 ml of cyclohexane in a beaker at room temperature, and the solution of the siloxane compound was then added to the SBS triblock copolymer solution and thoroughly mixed with stirring for 60 minutes. The mixed solution was slowly added to hot water with stirring, and the solvent removed to obtain polymer colloidal particles. After drying with hot air at 100° C., the polymer colloidal particles were pressed by a heated mill and molded to test abrasion resistance. The result is listed in Table 4.

TABLE 4

| | | Abrasion | Abrasion |
|---|---|---|---|
| | siloxane compound | resistance | resistance |
| Example | Added value (wt %) | -B(Akron) (cc) | -C(NBS) (rev.) |
| Example 7 | 0 | 0.72 (0.22) | 210 |
| | 2.0 | 0.10 (0.02) | 830 |

Abrasion resistance B(Akron) test condition: 6 lb/15°/3300 rev.
Abrasion resistance B(Akron) test condition in brackets: 2 lb/15°/2000 rev.
Abrasion resistance G(NBS) test condition: The number of revolutions
required to abrade 1.54 mm of the test specimen.
Example 7: The siloxane compound has a formula as below, and a
viscosity of about 210000 cp:

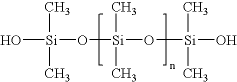

### EXAMPLE 8

Similar to Example 6, the SBS copolymer was melted in a heated mill, and 2 wt % of the siloxane compound was applied into the mill directly and thoroughly mixed. After pressing and molding, abrasion resistance was tested, and the result is listed in Table 5.

In addition, 2 wt % of the siloxane compound was blended with polymers of polystyrene (PS), polyethylene (PE), polypropylene (PP), poly(methyl methacrylate) (PMMA), and polyethylene-vinyl acetate (EVA) individually in the ratio of 1:1 by weight to melt by heating and form masterbatchs. Each masterbatch was thoroughly blended with the SBS triblock copolymers, and then pressed and molded to test abrasion resistance. The result is listed in Table 5.

TABLE 5

| | siloxane | Abrasion | Abrasion |
|---|---|---|---|
| | compound | resistance - | resistance - |
| | Added | B (Akron) | C (NBS) |
| homopolymer | value (g) | (cc) | (rev.) |
| SBS | 310 | 1.0 | 222 |
| siloxane compound/SBS | 6.3/310 | 0.10 | 854 |
| siloxane compound-PS/SBS | 12.6/310 | 0.17 | 589 |
| siloxane compound-PE/SBS | 12.6/310 | 0.17 | 511 |
| siloxane compound-PP/SBS | 12.6/310 | 0.19 | 514 |
| siloxane compound-PMMA/SBS | 12.6/310 | 0.21 | 445 |
| siloxane compound-EVA/SBS | 12.6/310 | 0.21 | 412 |

Abrasion resistance B(Akron) test condition: 6 lb/15°/3300 rev.
Abrasion resistance C(NBS) test condition: The number of revolutions required to abrade 1.54 mm of the test specimen.
PS: polystyrene;
PE: polyethylene;
PP: polypropylene;
PMMA: poly(methyl methacrylate);
EVA: polyethylene-vinyl acetate.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A conjugated diene-vinyl aromatic hydrocarbon copolymer containing a siloxane compound, comprising:
100 parts by weight of the conjugated diene-vinyl aromatic hydrocarbon copolymer; and 0.1 to 50 parts by weight of the siloxane compound of the formula: 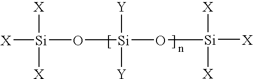
wherein each X independently represents C₁˜C₁₂ alkyl, C₁˜C₁₂ alkoxy, C₁˜C₁₂ cycloalkoxy, C₁˜C₁₂ alkenyl, C₁˜C₁₂ alkylamino, C₁˜C₁₂ alkylol, C₁˜C₁₂ thiol, halogen, carboxyl, hydroxyl, amino, aryl, or hydrogen; each Y independently represents C₁˜C₁₂ alkyl, C₁˜C₁₂ alkoxy, C₁˜C₁₂ cycloalkoxy, C₁˜C₁₂ alkenyl, C₁˜C₁₂ alkylamino, C₁˜C₁₂ alkylol, C₁˜C₁₂ thiol, halogen, carboxyl, aryl, or hydrogen; and n is an integer between 5 and 10,000.

2. The copolymer as claimed in claim 1, wherein the viscosity of the siloxane compound is about 100-300000 cp.

3. The copolymer as claimed in claim 1, wherein n is an integer between 600 and 7,000.

4. The copolymer as claimed in claim 1, wherein the siloxane compound is present in an amount of about 1 to 2.5 parts by weight.

5. The copolymer as claimed in claim 1, wherein the conjugated diene-vinyl aromatic hydrocarbon copolymer is a block copolymer.

6. The copolymer as claimed in claim 1, wherein the conjugated diene-vinyl aromatic hydrocarbon copolymer has a number average molecular weight of about 50000 to 1000000 grams per mole.

7. The copolymer as claimed in claim 1, wherein the vinyl aromatic hydrocarbon is about 10 to 50 wt %, based on the total amount of the conjugated diene-vinyl aromatic hydrocarbon copolymer.

8. A method for improving abrasion resistance of a conjugated diene-vinyl aromatic hydrocarbon copolymer, comprising:
adding a siloxane compound to the conjugated diene-vinyl aromatic hydrocarbon copolymer; wherein the siloxane compound is about 0.1 to 50 parts by weight, based on 100 parts by weight of the conjugated diene-vinyl aromatic hydrocarbon copolymer; and
the siloxane compound has a formula as below: 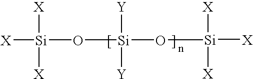
wherein each X independently represents C₁˜C₁₂ alkyl, C₁˜C₁₂ alkoxy, C₁˜C₁₂ cycloalkoxy, C₁˜C₁₂ alkenyl, C₁˜C₁₂ alkylamino, C₁˜C₁₂ alkylol, C₁˜C₁₂ thiol, halogen, carboxyl, hydroxyl, amino, aryl, or hydrogen; each Y independently represents C₁˜C₁₂ alkyl, C₁˜C₁₂ alkoxy, C₁˜C₁₂ cycloalkoxy, C₁˜C₁₂ alkenyl, C₁˜C₁₂ alkylamino, C₁˜C₁₂ alkylol, C₁˜C₁₂ thiol, halogen, carboxyl, aryl, or hydrogen; and n is an integer between 5 and 10,000.

9. The method as claimed in claim 8, further comprising:
providing a solution of the conjugated diene-vinyl aromatic hydrocarbon copolymer; providing a solution of the siloxane compound by dissolving the siloxane compound in an organic solvent; mixing the solution of the siloxane compound with the solution of the conjugated diene-vinyl aromatic hydrocarbon copolymer; and removing the solvent to obtain the conjugated diene-vinyl aromatic hydrocarbon copolymer with improved abrasion resistance.

10. The method as claimed in claim 9, wherein the organic solvent used to dissolve the siloxane compound comprises aromatic hydrocarbon, straight or branched hydrocarbon, cycloalkyl ether, or alicyclic hydrocarbon.

11. The method as claimed in claim 8, further comprising:
providing the conjugated diene-vinyl aromatic hydrocarbon copolymer in a melt state; directly blending the siloxane compound with the conjugated diene-vinyl aromatic hydrocarbon copolymer; and obtaining the conjugated diene-vinyl aromatic hydrocarbon copolymer containing the siloxane compound with improved abrasion resistance by press molding or injection molding.

12. The method as claimed in claim 8, further comprising:
providing the conjugated diene-vinyl aromatic hydrocarbon copolymer in a melt state; blending the siloxane compound with homopolymer to form a masterbatch; blending the masterbatch with the conjugated diene-vinyl aromatic hydrocarbon copolymer; and
obtaining the conjugated diene-vinyl aromatic hydrocarbon copolymer containing the siloxane compound with improved abrasion resistance by press molding or injection molding.

13. The method as claimed in claim 12, wherein the masterbatch has a ratio of siloxane compound to homopolymer of about 1:100˜100:1.

14. The method as claimed in claim 12, wherein the temperature of forming the masterbatch is substantially between 100 and 250° C.

15. The method as claimed in claim 12, wherein the polymer blended with the siloxane compound is a homopolymer.

16. The method as claimed in claim 15, wherein the homopolymer comprises polyolefins, ethylenically unsaturated polyester, polyaromatic hydrocarbons derivatives thereof, or combinations thereof.

17. The method as claimed in claim 12, wherein the polymer blending with the siloxane compound is a copolymer.

18. The method as claimed in claim 17, wherein the copolymer comprises a copolymer of olefin and aromatic hydrocarbon, polyolefin, a copolymer of olefin and ethylenically unsaturated ester, derivatives thereof, or combinations thereof.

19. The method as claimed in claim 18, wherein the abrasion resistance of the conjugated diene-vinyl aromatic hydrocarbon copolymer containing the siloxane compound is twice that of the conjugated diene-vinyl aromatic hydrocarbon copolymer in absence of the siloxane compound.

20. The method as claimed in claim 18, wherein the abrasion resistance of the conjugated diene-vinyl aromatic hydrocarbon copolymer containing the siloxane compound is ten times that of the conjugated diene-vinyl aromatic hydrocarbon copolymer in absence of the siloxane compound.

21. The method as claimed in claim 8, wherein the viscosity of the siloxane compound is about 100-300000 cp.

22. The method as claimed in claim 8, wherein n is an integer between 600 and 7,000.

23. The method as claimed in claim 8, wherein the siloxane compound is present in an amount of about 1 to 2.5 parts by weight.

24. The method as claimed in claim 8, wherein the conjugated diene-vinyl aromatic hydrocarbon copolymer is a block copolymer or alternating copolymer.

25. The method as claimed in claim 8, wherein the conjugated diene-vinyl aromatic hydrocarbon copolymer has a number average molecular weight of about 50000 to 1000000 grams per mole.

26. The method as claimed in claim 8, wherein the vinyl aromatic hydrocarbon is about 10 to 50 wt %, based on the total amount of the conjugated diene-vinyl aromatic hydrocarbon copolymer.
